(19) United States
(12) Patent Application Publication
(10) Pub. No.: US 2025/0094850 A1
(43) Pub. Date: Mar. 20, 2025

(54) EFFICIENT QUANTUM CIRCUIT FOR QUANTUM FOURIER TRANSFORM IN FAULT-TOLERANT QUANTUM COMPUTING

(71) Applicant: ELECTRONICS AND TELECOMMUNICATIONS RESEARCH INSTITUTE, Daejeon (KR)

(72) Inventors: Taewan KIM, Daejeon (KR); Jeongho BANG, Daejeon (KR); Kyunghyun BAEK, Daejeon (KR); Yongsoo HWANG, Daejeon (KR)

(21) Appl. No.: 18/535,714

(22) Filed: Dec. 11, 2023

(30) Foreign Application Priority Data
Sep. 19, 2023 (KR) 10-2023-0125090

(51) Int. Cl. G06N 10/40; G06F 17/14

(52) U.S. Cl. CPC G06N 10/40; G06F 17/14

(57) ABSTRACT

Disclosed is a quantum circuit, which includes input qubit lines, auxiliary qubit lines, and an R(θ) gate layer connected to the input qubit lines and the auxiliary qubit lines, and the R(θ) gate layer performs a plurality of R(θ) gate operations at once based on input qubits of the input qubit lines and auxiliary qubits of the auxiliary qubit lines, and the quantum circuit outputs Fourier transform results with respect to the input qubits as output qubits, based on a result of the plurality of R(θ) gate operations, without additional R(θ) gate operations.

### CROSS-REFERENCE TO RELATED APPLICATIONS

This application claims priority under 35 U.S.C. § 119 to Korean Patent Application No. 10-2023-0125090 filed on Sep. 19, 2023, in the Korean Intellectual Property Office, the disclosures of which are incorporated by reference herein in their entireties.

### BACKGROUND

Embodiments of the present disclosure described herein relate to an electronic device, and more particularly, relate to a method of efficiently mapping a quantum Fourier transform circuit.

The physical characteristics of a quantum computer are different from those of a conventional computer. Therefore, a logically organized quantum algorithm to run on a quantum computer should be converted into a quantum circuit based on the physical characteristics of the quantum computer. The process of converting a quantum algorithm into a quantum circuit is called quantum circuit mapping.

The computation times of gates of the quantum circuit may be different to each other. When quantum algorithms are optimized to complete operations in a shorter amount of time, the computation time of the mapped quantum circuit may also be shortened.

### SUMMARY

Embodiments of the present disclosure provide a method for efficiently mapping a quantum Fourier transform circuit with shorter computation time.

According to an embodiment of the present disclosure, a quantum circuit includes input qubit lines, auxiliary qubit lines, and an R(θ) gate layer connected to the input qubit lines and the auxiliary qubit lines, and the R(θ) gate layer performs a plurality of R(θ) gate operations at once based on input qubits of the input qubit lines and auxiliary qubits of the auxiliary qubit lines, and the quantum circuit outputs Fourier transform results with respect to the input qubits as output qubits, based on a result of the plurality of R(θ) gate operations, without additional R(θ) gate operations.

According to an embodiment, zero qubits may be received as the auxiliary qubits.

According to an embodiment, the R(θ) gate layer may perform the plurality of R(θ) gate operations on both the input qubits and the auxiliary qubits, respectively.

According to an embodiment, first auxiliary qubits among the auxiliary qubits may be used to convert a CRₙ gate of a quantum Fourier transform circuit to an Rₙ gate.

According to an embodiment, second auxiliary qubits among the auxiliary qubits may be used to move the Rₙ gate located on a specific qubit line among the input qubit lines and first auxiliary qubit lines to some of second auxiliary qubit lines.

According to an embodiment, the quantum circuit may further include a gate group that receives the input qubits of the input qubit lines, one qubit of the first auxiliary qubits of the first auxiliary qubit lines, and at least two second auxiliary qubits of at least two of the second auxiliary qubit lines, and outputs an operation result qubit corresponding to the one qubit.

According to an embodiment, the gate group may include: a first CNOT gate coupled to a qubit line of the one qubit and controlled by a qubit line of one second auxiliary qubit of the at least two second auxiliary qubits, a second CNOT gate connected to the qubit line of the one second auxiliary qubit and controlled by the qubit line of the one qubit, a third CNOT gate connected to a qubit line of another second auxiliary qubit of the at least two second auxiliary qubits and controlled by the qubit line of the one second auxiliary qubit, a first M_{z} gate connected to the one qubit, an Mₓ gate that operates based on a measurement result of the first M_{z} gate and is connected to the another second auxiliary qubit, a second M_{z} gate that operates based on the measurement result of the first M_{z} gate and is connected to the another second auxiliary qubit, a first Z gate that operates based on a measurement result of the Mₓ gate and is connected to the one second auxiliary qubit, and a second Z gate that operates based on a measurement result of the second M_{z} gate and is connected to the one second auxiliary qubit.

According to an embodiment, the gate group, a first Hadamard gate connected to the one second auxiliary qubit, an R(θ₃) gate of the gate layer connected to the one second auxiliary qubit, a second Hadamard gate connected to the another second auxiliary qubit, and an R(θ₂) gate of the gate layer connected to the another second auxiliary qubit may correspond to an R(θ₃) gate connected to the one qubit.

According to an embodiment, the gate group may include a first CNOT gate coupled to a qubit line of the one qubit and controlled by a qubit line of one second auxiliary qubit of the at least two second auxiliary qubits, a second CNOT gate connected to the qubit line of the one second auxiliary qubit and controlled by the qubit line of the one qubit, a third CNOT gate connected to a qubit line of another second auxiliary qubit of the at least two second auxiliary qubits and controlled by the qubit line of the one second auxiliary qubit, a fourth CNOT gate connected to a qubit line of the other second auxiliary qubit of the at least two second auxiliary qubits and controlled by the qubit line of the one second auxiliary qubit, a first M_{z} gate connected to the one qubit, a first Mₓ gate that operates based on a measurement result of the first M_{z} gate and is connected to the another second auxiliary qubit, a second Mₓ gate that operates based on the measurement result of the first M_{z} gate and is connected to the other second auxiliary qubit, a first Z gate that operates based on a measurement result of the first Mₓ gate and is connected to the one second auxiliary qubit, a second Z gate that operates based on a measurement result of the second Mₓ gate and is connected to the one second auxiliary qubit, a second M_{z} gate that operates based on the measurement result of the first M_{z} gate and is connected to the another second auxiliary qubit, a third Mₓ gate that operates based on the measurement result of the second M_{z} gate and is connected to the other second auxiliary qubit, a third Z gate that operates based on a measurement result of the third Mₓ gate and is connected to the one second auxiliary qubit, a third M_{z} gate that operates based on the measurement result of the second M_{z} gate and is connected to the other second auxiliary qubit, and a fourth Z gate that operates based on the measurement result of the second M_{z} gate and is connected to the one second auxiliary qubit.

According to an embodiment, the gate group, a first Hadamard gate connected to the one second auxiliary qubit, an R(θ₄) gate of the gate layer connected to the one second auxiliary qubit, a second Hadamard gate connected to the another second auxiliary qubit, an R(θ₃) gate of the gate layer connected to the another second auxiliary qubit, a third Hadamard gate connected to the other second auxiliary qubit, and an R(θ₂) gate of the gate layer connected to the other second auxiliary qubit may correspond to an R(θ₄) gate connected to the one qubit.

According to an embodiment, the gate group, a first Hadamard gate connected to the one second auxiliary qubit, an R(θ³⁴) gate of the gate layer connected to the one second auxiliary qubit, a second Hadamard gate connected to the another second auxiliary qubit, an R(θ²³) gate of the gate layer connected to the another second auxiliary qubit, a third Hadamard gate connected to the other second auxiliary qubit, and an R(θ¹²) gate of the gate group connected to the other second auxiliary qubit may correspond to an R(θ³⁴) gate connected to the one qubit.

According to an embodiment of the present disclosure, a method of mapping a quantum Fourier transform circuit includes replacing first circuits with second circuits by adding first auxiliary qubits to the quantum Fourier transform circuit, integrating R(θ) gates into one layer by adding second auxiliary qubits to the replaced quantum Fourier transform circuit, and performing a quantum circuit transformation, and the integrating of into the one layer includes generating an R(θ) gate layer that performs a plurality of R(θ) gate operations at once based input qubits of input qubit lines and auxiliary qubits of second auxiliary qubit lines.

According to an embodiment, a depth of the R(θ) gate of the quantum Fourier transform circuit in which the quantum circuit transformation is performed may be 1.

According to an embodiment, the method may further include receiving zero qubits as the first auxiliary qubits.

According to an embodiment, the method may further include receiving zero qubits as the second auxiliary qubits.

According to an embodiment, the method may further include outputting operation results of output qubits and the first auxiliary qubits through operations of the quantum Fourier transform circuit in which the quantum circuit transformation is performed.

According to an embodiment, the method may further include exhausting the second auxiliary qubits in operations of the quantum Fourier transform circuit in which the quantum circuit transformation is performed.

According to an embodiment, the method may further include performing the plurality of R(θ) gate operations on all of the input qubits, the first auxiliary qubits, and the second auxiliary qubits, respectively, using the R(θ) gate layer.

According to an embodiment, the first circuits may include CRₙ gates, and the second circuits may include Rₙ gates and CNOT gates.

### BRIEF DESCRIPTION OF THE FIGURES

The above and other objects and features of the present disclosure will become apparent by describing in detail embodiments thereof with reference to the accompanying drawings.

FIG. 1 illustrates a first quantum circuit according to an embodiment of the present disclosure.

FIG. 2 illustrates examples of a first circuit, a second circuit, a third circuit, and a fourth circuit that are equivalent to one another.

FIG. 3 illustrates an example of a second quantum circuit in which a first quantum circuit of FIG. 1 is converted based on equivalent circuits of FIG. 2.

FIG. 4 illustrates examples of a fifth circuit and a sixth circuit that are equivalent circuits according to an embodiment of the present disclosure.

FIG. 5 illustrates an example of a method of replacing CRₙ gates of a first quantum circuit with an Rₙ₊₁ gate and a Rₙ₊₁^{†} gate.

FIG. 6 illustrates an example of a third quantum circuit in which a first quantum circuit of FIG. 1 is converted based on FIGS. 4 and 5.

FIG. 7 illustrates an example of a first partial quantum circuit of FIG. 6.

FIG. 8 illustrates examples of a second partial quantum circuit and a third partial quantum circuit of FIG. 6.

FIGS. 9 and 10 illustrate examples of a first partial quantum circuit, a second partial quantum circuit, and a third partial quantum circuit in which some of gates of a first partial quantum circuit, a second partial quantum circuit, and a third partial quantum circuit of FIGS. 7 and 8 are combined.

FIG. 11 illustrates an equivalent circuit of an R(θ₃) gate.

FIG. 12 illustrates an equivalent circuit of an R(θ₄) gate.

FIG. 13 illustrates an equivalent circuit of an R(θ³⁴) gate.

FIG. 14 illustrates examples of applying equivalent circuits of FIGS. 11, 12, and 13 to a second partial quantum circuit of FIG. 10.

FIG. 15 illustrates an example of applying an equivalent circuit of FIG. 11 to a third partial quantum circuit of FIG. 10.

FIGS. 16 and 17 illustrate a modified quantum circuit 4a and a modified quantum circuit 4b, respectively.

FIG. 18 illustrates an example of how to modify a quantum Fourier transform circuit.

FIG. 19 illustrates a quantum system according to an embodiment of the present disclosure.

### DETAILED DESCRIPTION

Hereinafter, embodiments of the present disclosure will be described in detail and clearly to such an extent that an ordinary one in the art easily implements the present disclosure.

By way of example, quantum circuit data generated and managed on a digital computer before being mapped into an actual quantum circuit may be called a ‘quantum algorithm’. After being mapped into an actual quantum circuit, the quantum circuit may be called a ‘quantum circuit’. However, in embodiments of the present disclosure, a strict distinction between the ‘quantum algorithm’ and the ‘quantum circuit’ may be unnecessary. For brevity of description, below, the ‘quantum algorithm’ may refer to the ‘quantum algorithm’ or the ‘quantum circuit’, and as in the above description, the ‘quantum circuit’ may refer to the ‘quantum algorithm’ or the ‘quantum circuit’.

In addition, the term ‘circuit’ may be used to distinguish the components of a quantum circuit from each other, but the term ‘circuit’ will also refer to the components of the quantum circuit (or the quantum algorithm).

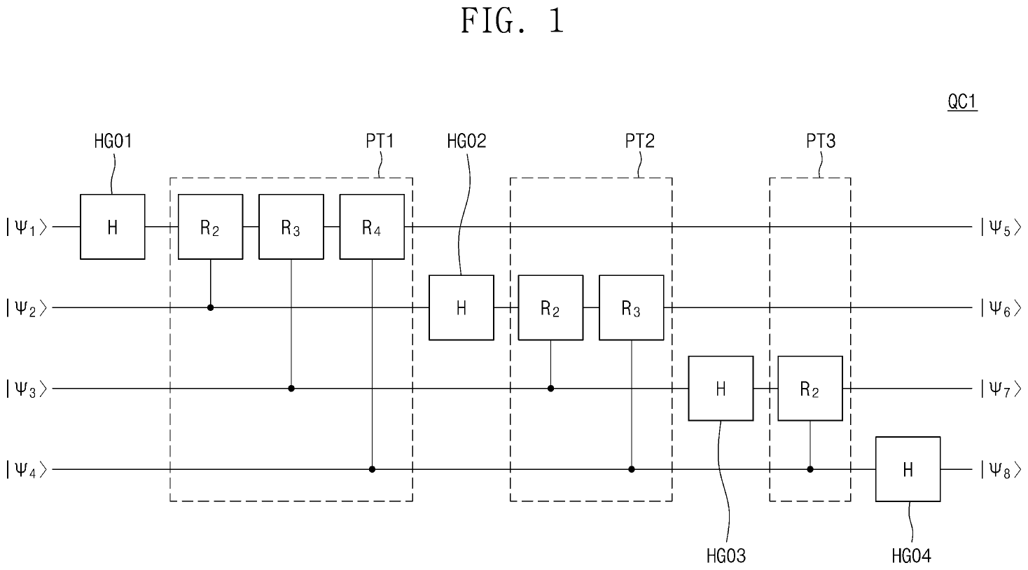

FIG. 1 illustrates a first quantum circuit QC1 according to an embodiment of the present disclosure. For example, the first quantum circuit QC1 may correspond to a quantum Fourier transform circuit. Referring to FIG. 1, a first qubit |Ψ₁>, a second qubit |Ψ₂22 , a third qubit |Ψ₃>, and a fourth qubit |Ψ₄> may be input qubits of the first quantum circuit QC1. A fifth qubit |Ψ5>, a sixth qubit |Ψ6>, a seventh qubit |Ψ7>, and an eighth qubit |Ψ8> may be output qubits of the first quantum circuit QC1.

The first quantum circuit QC1 may include a first Hadamard gate HG01 connected to a qubit line of the first qubit |Ψ₁> as a Hadamard gate ‘H’.

Subsequent to the first Hadamard gate HG01, the first quantum circuit QC1 may further include a first partial quantum circuit PT1 connected to qubit lines of the first qubit |Ψ₁>, the second qubit |Ψ₂22 , the third qubit |Ψ₃>, and the fourth qubit |Ψ₄>. The first partial quantum circuit PT1 may include a CR₂ gate (a controlled gate filled with R₂) that is controlled by the qubit line of the second qubit |Ψ₂>, a CR₃ gate (a controlled gate filled with R₃) that is controlled by the qubit line of the third qubit |Ψ₃>, and a CR₄ gate (a controlled gate filled with R₄) that is controlled by the qubit line of the fourth qubit |Ψ₄>.

Subsequent to the first partial quantum circuit PT1, the first quantum circuit QC1 may further include a second Hadamard gate HG02 connected to the qubit line of the second qubit |Ψ₂>.

Subsequent to the second Hadamard gate HG02, the first quantum circuit QC1 may further include a second partial quantum circuit PT2 connected to the qubit lines of the second qubit |Ψ₂>, the third qubit |Ψ₃>, and the fourth qubit |Ψ₄>. The second partial quantum circuit PT2 may include the CR₂ gate (the controlled gate filled with R₂) that is controlled by the qubit line of the third qubit |Ψ₃>, and the CR₃ gate (the controlled gate filled with R₃) that is controlled by the qubit line of the fourth qubit |Ψ₄>.

Subsequent to the second partial quantum circuit PT2, the first quantum circuit QC1 may further include a third Hadamard gate HG03 connected to the qubit line of the third qubit |Ψ₃>.

A third partial quantum circuit PT3 may include the CR₂ gate (the controlled gate filled with R₂) that is controlled by the qubit line of the fourth qubit |Ψ₄>.

Subsequent to the third partial quantum circuit PT3, the first quantum circuit QC1 may further include a fourth Hadamard gate HG04 connected to the qubit line of the fourth qubit |Ψ₄>.

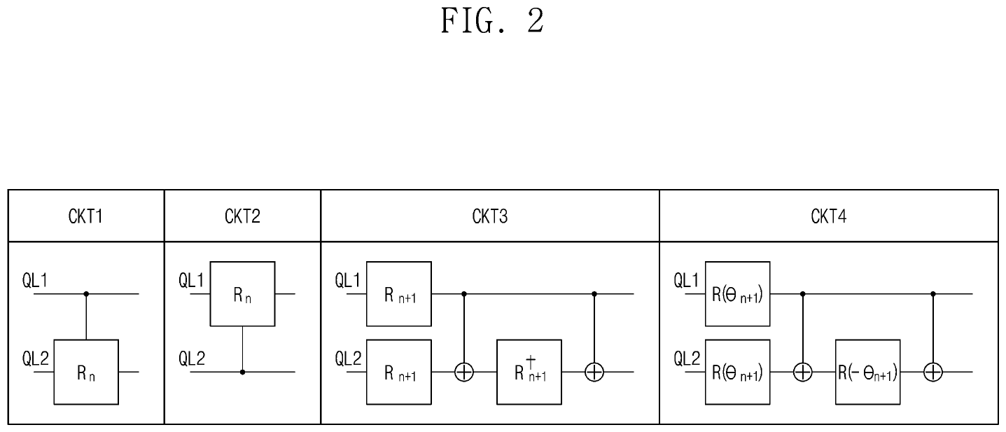

FIG. 2 illustrates examples of a first circuit CKT1, a second circuit CKT2, a third circuit CKT3, and a fourth circuit CKT4 that are equivalent to one another. Referring to FIG. 2, the first circuit CKT1 may include a CRₙ gate (a controlled gate filled with Rₙ) connected to a second qubit line QL2 and controlled by a first qubit line QL1. The second circuit CKT2 may include the CRₙ gate (the controlled gate filled with Rₙ) connected to the first qubit line QL1 and controlled by the second qubit line QL2.

The third circuit CKT3 may include an Rₙ₊₁ gate connected to the first qubit line QL1, an Rₙ₊₁ gate connected to the second qubit line QL2, a CNOT gate (a controlled gate connected to ⊕) connected to the second qubit line QL2 and controlled by the first qubit line QL1 subsequent to the Rₙ₊₁ gate of the first qubit line QL1 and the Rₙ₊₁ gate of the second qubit line QL2, an Rₙ₊₁^{†} gate connected to the second qubit line QL2 subsequent to the CNOT gate (the controlled gate connected to ⊕), and a CNOT gate (the controlled gate connected to ⊕) connected to the second qubit line QL2 and controlled by first qubit line QL1 subsequent to the Rₙ₊₁^{†} gate.

The fourth circuit CKT4 may include an R(θₙ₊₁) gate connected to the first qubit line QL1, an R(θₙ₊₁) gate connected to the second qubit line QL2, a CNOT gate (the controlled gate connected to ⊕) connected to the second qubit line QL2 and controlled by the first qubit line QL1 subsequent to the R(θₙ₊₁) gate of the first qubit line QL1 and the R(θₙ₊₁) gate of the second qubit line QL2, an R(−θₙ₊₁) gate connected to the second qubit line QL2 subsequent to the CNOT gate (the controlled gate connected to ⊕), and a CNOT gate (the controlled gate connected to ⊕) connected to the second qubit line QL2 and controlled by the first qubit line QL1 subsequent to the R(−θₙ₊₁) gate.

As illustrated in the third circuit CKT3 and the fourth circuit CKT4, the Rₙ₊₁ gate and the R(θₙ₊₁) gate (or R_{z}(θₙ₊₁) gate) may be equivalent circuits to each other. In addition, the. ** gate and R(−θₙ₊₁) gate (or R_{z}(−θₙ₊₁) gate) may be equivalent circuits to each other.

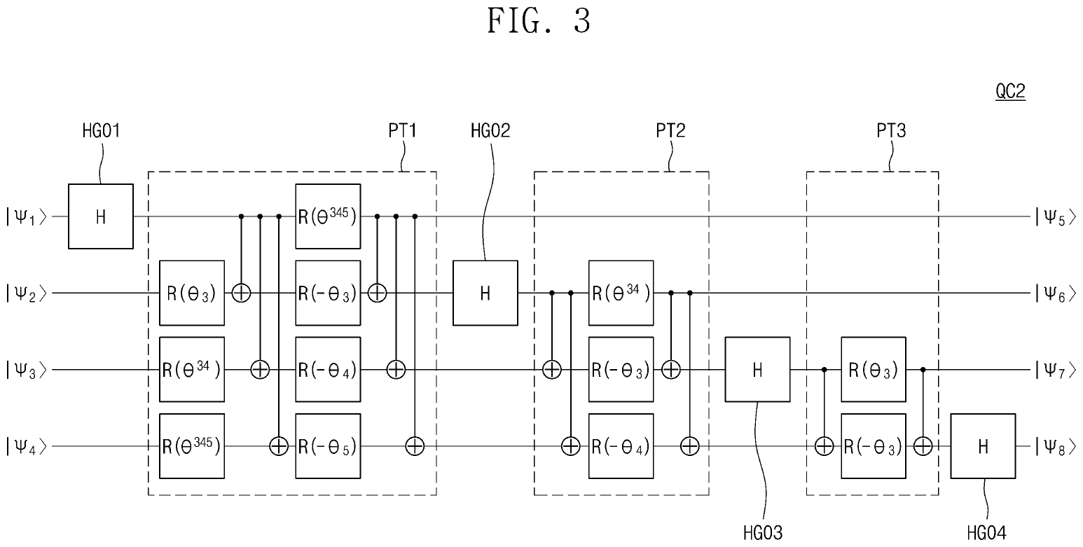

FIG. 3 illustrates an example of a second quantum circuit QC2 in which the first quantum circuit QC1 of FIG. 1 is converted based on equivalent circuits of FIG. 2. When comparing FIGS. 1 and 3, each of the CRₙ gates of the first partial quantum circuit PT1, the second partial quantum circuit PT2, and the third partial quantum circuit PT3 of FIG. 1 may be replaced with the CNOT gates (the controlled gate connected to ⊕), the R(θₙ₊₁) gates (or the R_{z}(θₙ₊₁) gates), and the R(−θₙ₊₁) gates (or the R_{z}(−θₙ₊₁) gates).

The first partial quantum circuit PT1 may include an R(θ₃) gate connected to the qubit line of the second qubit |Ψ₂>, an R(θ³⁴) gate connected to the qubit line of the third qubit |Ψ₃>, and an R(θ³⁴⁵) gate connected to the qubit line of the fourth qubit |Ψ₄>. The ‘θ³⁴’ may be ‘θ₃+θ₄’. The ‘θ³⁴⁵’ may be ‘θ₃+θ₄+θ₅’.

The first partial quantum circuit PT1 may further include a CNOT gate (the controlled gate connected to ⊕) connected to ⊕) the qubit line of the second qubit |Ψ₂> and controlled by the qubit line of the first qubit |Ψ₁>, a CNOT gate (the controlled gate connected to ⊕) connected to ⊕) the qubit line of the third qubit |Ψ₃> and controlled by the qubit line of the first qubit |Ψ₁>, and a CNOT gate (the controlled gate connected to ⊕) connected to the qubit line of the fourth qubit |Ψ₄> and controlled by the qubit line of the first qubit |Ψ₁>.

The first partial quantum circuit PT1 may further include an R(θ³⁴⁵) gate connected to the qubit line of the first qubit |Ψ₁>, an R(−θ₃) gate connected to the qubit line of the second qubit |Ψ₂>, an R(−θ₄) gate connected to the qubit line of the third qubit |Ψ₃>, and an R(−θ₅) gate connected to the qubit line of the fourth qubit |Ψ₄>.

The first partial quantum circuit PT1 may further include a CNOT gate (the controlled gate connected to ⊕) connected to the qubit line of the second qubit |Ψ₂> and controlled by the qubit line of the first qubit |Ψ₁>, a CNOT gate (the controlled gate connected to ⊕) connected to the qubit line of the third qubit |Ψ₃> and controlled by the qubit line of the first qubit |Ψ₁>, and a CNOT gate (the controlled gate connected to ⊕) connected to the qubit line of the fourth qubit |Ψ₄> and controlled by the qubit line of the first qubit |Ψ₁>.

The second partial quantum circuit PT2 may include a CNOT gate (the controlled gate connected to ⊕) connected to the qubit line of the third qubit |Ψ₃> and controlled by the qubit line of the second qubit |Ψ₂>, and a CNOT gate (the controlled gate connected to ⊕) connected to the qubit line of the fourth qubit |Ψ₄> and controlled by the qubit line of the second qubit |Ψ₂>.

The second partial quantum circuit PT2 may further include an R(θ³⁴) gate connected to the qubit line of the second qubit |Ψ₂>, an R(−θ₃) gate connected to the qubit line of the third qubit |Ψ₃>, and an R(−θ₄) gate connected to the qubit line of the fourth qubit |Ψ₄>.

The second partial quantum circuit PT2 may further include a CNOT gate (the controlled gate connected to ⊕) connected to the qubit line of the third qubit |Ψ₃> and controlled by the qubit line of the second qubit |Ψ₂>, and a CNOT gate (the controlled gate connected to ⊕) connected to the qubit line of the fourth qubit |Ψ₄> and controlled by the qubit line of the second qubit |Ψ₂>.

The third partial quantum circuit PT3 may include a CNOT gate (the controlled gate connected to ⊕) connected to the qubit line of the fourth qubit |Ψ₄> and controlled by the qubit line of the third qubit |Ψ₃>.

The third partial quantum circuit PT3 may further include an R(θ₃) gate connected to the qubit line of the third qubit |Ψ₃>, and an R(−θ₃) gate connected to the qubit line of the fourth qubit |Ψ₄>.

The third partial quantum circuit PT3 may include a CNOT gate (the controlled gate connected to ⊕) connected to the qubit line of the fourth qubit |Ψ₄> and controlled by the qubit line of the third qubit |13>.

In the second quantum circuit QC2, a depth of the R(θₙ₊₁) gates (or (R_{z}(θₙ₊₁) gates) may refer to the maximum number of the R(θₙ₊₁) gates (or (R_{z}(θₙ₊₁) gates) through which each of the input qubits (e.g., the first qubit |Ψ₁>, the second qubit |Ψ₂>, the third qubit |Ψ₃>, and the fourth qubit |Ψ₄>) passes until the each of the input qubits is output to a corresponding output qubit among the output qubits (e.g., the fifth qubit |Ψ₅>, the sixth qubit |Ψ₆>, the seventh qubit |Ψ₇>, and the eighth qubit |Ψ₈>). In the second quantum circuit QC2, the depth of R(θₙ₊₁) gates (or (R_{z}(θₙ₊₁) gates)) may be ‘4’.

The R(θₙ₊₁) gate (or R_{z}(θₙ₊₁) gate) among quantum gates may have a relatively long computation time. To reduce the computation time of the R(θₙ₊₁) gate (or R_{z}(θₙ₊₁) gate), a method of approximating the R(θₙ₊₁) gate (or R_{z}(θₙ₊₁) gate) may be used. For example, the R(θ₄) gate may be approximated as R_{z}(π/8), for example with gates including ‘HTHTSHTHTSHTSHTHTHTHTHTSHTSHTSHTHTSHTSHTSHTSHTHTSHTS HTSHTHTHTSHTSHTSHTHTHTHTHTHTSHTSHTHTHTSHTSHTSHTSHTSHT SHTSHTSHTHTHTHTSHTSHTHTSHTSHTHTHTHTSHTSHTSHTHTSHTSHTH THTHTHTSHTHTSHTHTHTSHTSHTSHTSHTHTHTSHTHTSHTSHTHTHTHTS HTSHTHTSHTSHTHTSHTSHTSHTSHTHTSHTHTHTSHTH’. Likewise, the R(θₙ₊₁) gate (or R_{z}(θₙ₊₁) gate) requires the operations of multiple gates. Therefore, to reduce the calculation time of the quantum Fourier transform circuit, it is necessary to reduce the depth of the R(θₙ₊₁) gate (or R_{z}(θₙ₊₁) gate).

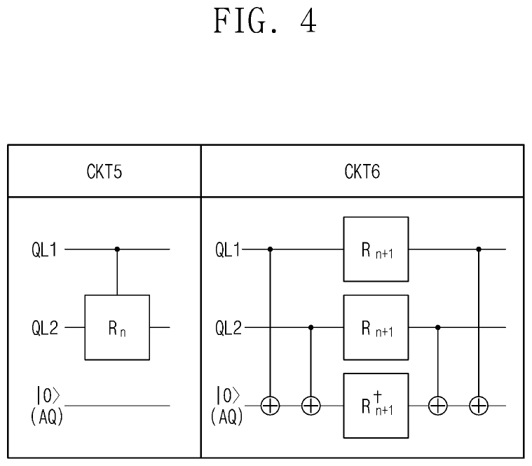

FIG. 4 illustrates an example of a fifth circuit CKT5 and a sixth circuit CKT6 that are equivalent circuits according to an embodiment of the present disclosure. Referring to FIG. 4, the fifth circuit CKT5 may include the CRₙ gate (the controlled gate filled with Rₙ) connected to the second qubit line QL2 and controlled by the first qubit line QL1. In the fifth circuit CKT5, a qubit line of an auxiliary qubit AQ, which is a zero qubit |0>, may not be used.

The sixth circuit CKT6 may include a CNOT gate (the controlled gate connected to ⊕) connected to the qubit line of the auxiliary qubit AQ and controlled by the first qubit line QL1, and a CNOT gate (the controlled gate connected to ⊕) connected to the qubit line of the auxiliary qubit AQ and controlled by the second qubit line QL2. The sixth circuit CKT6 may further include an Rₙ₊₁ gate connected to the first qubit line QL1, an Rₙ₊₁ gate connected to the second qubit line QL2, and a gate connected to the auxiliary qubit line. The sixth circuit CKT6 may include a CNOT gate (the controlled gate connected to ⊕) connected to the qubit line of the auxiliary qubit AQ and controlled by the first qubit line QL1, and a CNOT gate (the controlled gate connected to ⊕) connected to the qubit line of the auxiliary qubit AQ and controlled by the second qubit line QL2.

In the equivalent circuits of FIG. 2, one CRₙ gate may be replaced with the Rₙ₊₁ gates having the depth ‘2’, while in the equivalent circuit of FIG. 4, by adding one auxiliary qubit AQ, one CRₙ gate may be replaced with Rₙ₊₁ gates (or R(θₙ₊₁ gates)) having the depth ‘1’. Accordingly, the depth of the Rₙ₊₁ gates of the quantum Fourier transform circuit may be reduced.

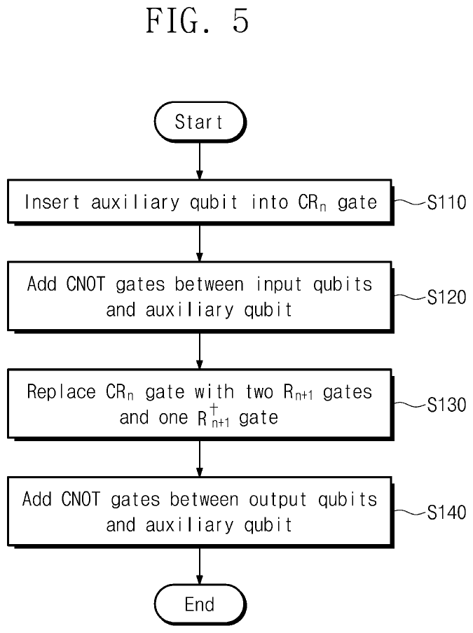

FIG. 5 illustrates an example of a method of replacing the CRₙ gates of the first quantum circuit QC1 with an Rₙ₊₁ gate and a R₊₁^{†} gate. Illustratively, the method of FIG. 5 may be performed by a digital computer configured to generate a quantum algorithm. Referring to FIG. 5, in operation S110, the digital computer may perform an operation of inserting an auxiliary qubit into the CRₙ gate (e.g., each of the CRₙ gates).

In operation S120, as illustrated in FIG. 4, the digital computer may add the CNOT gates between the input qubits and the auxiliary qubit.

In operation S130, as illustrated in FIG. 4, the digital computer may replace the CRₙ gate (e.g., each of the CRₙ gates) with two Rₙ₊₁ gates and one Rₙ₊₁^{†} gate.

In operation S140, as illustrated in FIG. 4, the digital computer may add the CNOT gates between the output qubits and the auxiliary qubit.

By performing the method of FIG. 5, each of the CRₙ gates of the first quantum circuit QC1, which is a Fourier quantum transform circuit, may be replaced with two Rₙ₊₁ gates of the depth ‘1’ and one Rₙ₊₁^{†} gate.

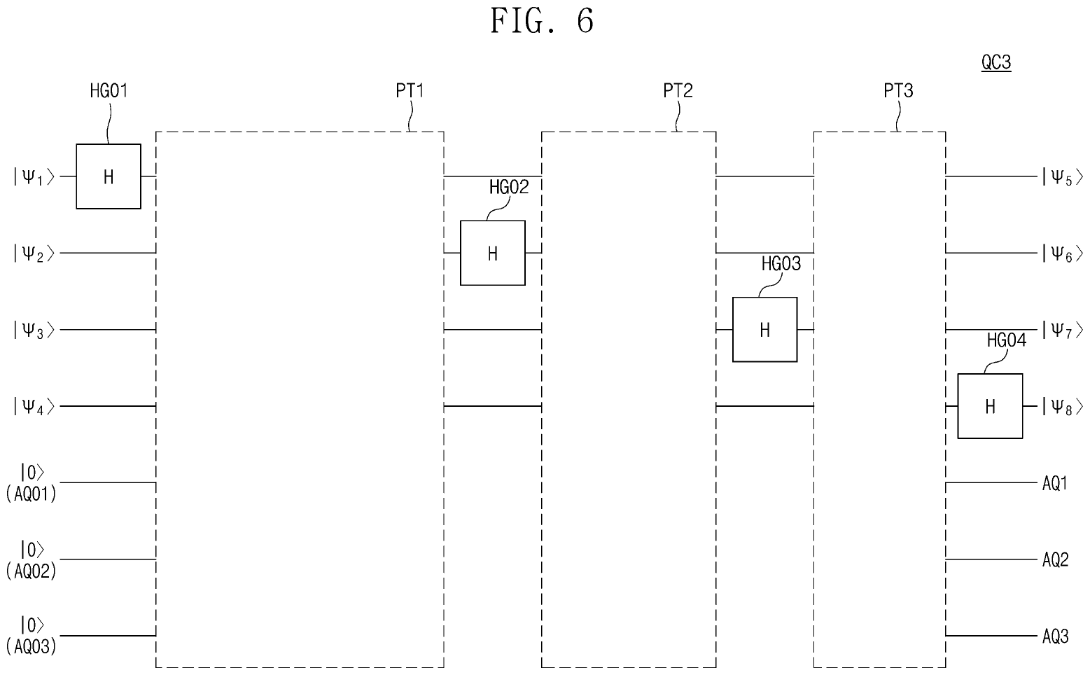

FIG. 6 illustrates an example of a third quantum circuit QC3 in which the first quantum circuit QC1 of FIG. 1 is converted based on FIGS. 2, 4 and 5. Referring to FIG. 6, the first qubit |Ψ₁>, the second qubit |Ψ₂>, the third qubit |Ψ₃>, and the fourth qubit |Ψ₄> may be input qubits of the third quantum circuit QC3. The fifth qubit |Ψ₅>, the sixth qubit |Ψ₆>, the seventh qubit |Ψ₇>, and the eighth qubit |Ψ₈> may be output qubits of the third quantum circuit QC3.

A first auxiliary qubit AQ01, a second auxiliary qubit AQ02, and a third auxiliary qubit AQ03, which are zero qubits |0>, may be used to replace each of the CRₙ gates with two Rₙ₊₁ gates (or the R(θₙ₊₁) gates or the R_{z}(θₙ₊₁) gates) of depth ‘1’ and one gate Rₙ₊₁^{†} (or the R(−θₙ₊₁) gate or the R_{z}(−θₙ₊₁) gate).

The third quantum circuit QC3 may include the first Hadamard gate HG01 connected to the qubit line of the first qubit |Ψ₁> as the Hadamard gate ‘H’.

Subsequent to the first Hadamard gate HG01, the third quantum circuit QC3 may further include the first partial quantum circuit PT1 connected to the qubit lines of the first qubit |Ψ₁>, the second qubit |Ψ₂>, the third qubit |Ψ₃>, and the fourth qubit |Ψ₄>.

Subsequent to the first partial quantum circuit PT1, the third quantum circuit QC3 may further include the second Hadamard gate HG02 connected to the qubit line of the second qubit |Ψ₂>.

Subsequent to the second Hadamard gate HG02, the third quantum circuit QC3 may further include the second partial quantum circuit PT2 connected to the qubit lines of the second qubit |Ψ₂>, the third qubit |Ψ₃>, and the fourth qubit |Ψ₄>.

Subsequent to the second partial quantum circuit PT2, the third quantum circuit QC3 may further include the third Hadamard gate HG03 connected to the qubit line of the third qubit |Ψ₃>.

Subsequent to the third Hadamard gate HG03, the third quantum circuit QC3 may further include the third partial quantum circuit PT3 connected to the qubit lines of the third qubit |Ψ₃> and the fourth qubit |Ψ₄>.

Subsequent to the third partial quantum circuit PT3, the third quantum circuit QC3 may further include the fourth Hadamard gate HG04 connected to the qubit line of the fourth qubit |Ψ₄>.

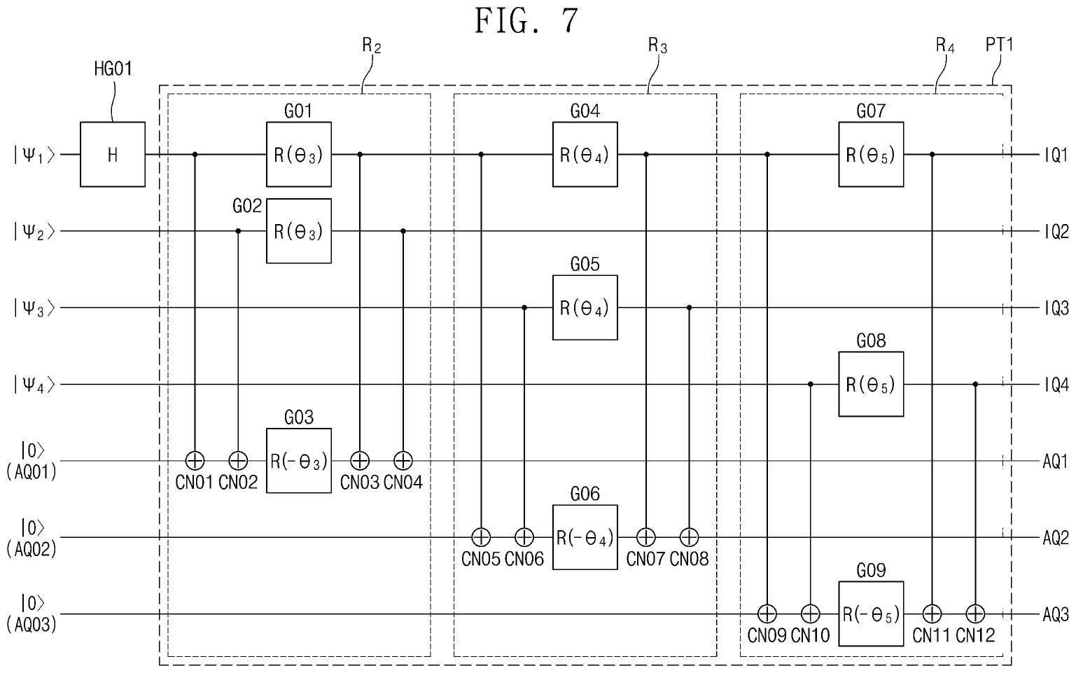

FIG. 7 illustrates an example of the first partial quantum circuit PT1 of FIG. 6. Referring to FIGS. 6 and 7, the CR₂ gate (the controlled gate filled with R₂) of the first partial quantum circuit PT1 may be replaced with a first CNOT gate CN01 connected to the qubit line of the first auxiliary qubit AQ01 and controlled by the qubit line of the first qubit |Ψ₁>, a second CNOT gate CN02 connected to the qubit line of the first auxiliary qubit AQ01 and controlled by the qubit line of the second qubit |Ψ₂> subsequent to the first CNOT gate CN01, an R(θ₃) gate G01 connected to the qubit line of the first qubit |Ψ₁> subsequent to the second CNOT gate CN02, an R(θ₃) gate G02 connected to the qubit line of the second qubit |Ψ₂> in parallel with the R(θ₃) gate G01 and subsequent to the second CNOT gate CN02, an R(−θ₃) gate G03 connected to the qubit line of the first auxiliary qubit AQ01 in parallel with the R(θ₃) gate G01 and the R(θ₃) gate G02 and subsequent to the second CNOT gate CN02, a third CNOT gate CN03 connected to the qubit line of the first auxiliary qubit AQ01 and controlled by the qubit line of the first qubit |Ψ₁> subsequent to the R(θ₃) gate G02 and the R(−θ₃) gate G03, and a fourth CNOT gate CN04 connected to the qubit line of the first auxiliary qubit AQ01 and controlled by the qubit line of the second qubit |Ψ₂> subsequent to the third CNOT gate CN03.

The CR₃ gate (the controlled gate filled with R₃) of the first partial quantum circuit PT1 may be replaced with a fifth CNOT gate CN05 connected to the qubit line of the second auxiliary qubit AQ02 and controlled by the qubit line of the first qubit |Ψ₁>, a sixth CNOT gate CN06 connected to the qubit line of the second auxiliary qubit AQ02 and controlled by the qubit line of the third qubit |Ψ₃> subsequent to the fifth CNOT gate CN05, an R(θ₄) gate G04 connected to the qubit line of the first qubit |Ψ₁> subsequent to the sixth CNOT gate CN06, an R(θ₄) gate G05 connected to the qubit line of the third qubit |Ψ₃> in parallel with the R(θ₄) gate G04 and subsequent to the sixth CNOT gate CN06, an R(−θ₄) gate G06 connected to the qubit line of the second auxiliary qubit AQ02 in parallel with the R(θ₄) gate G04 and the R(θ₄) gate G05 and subsequent to the sixth CNOT gate CN06, a seventh CNOT gate CN07 connected to the qubit line of the second auxiliary qubit AQ02 and controlled by the qubit line of the first qubit |Ψ₁> subsequent to the R(θ₄) gate G05 and the R(−θ₄) gate G06, and an eighth CNOT gate CN08 connected to the qubit line of the second auxiliary qubit AQ02 and controlled by the qubit line of the third qubit |Ψ₃> subsequent to the seventh CNOT gate CN07.

The CR₄ gate (the controlled gate filled with R₄) of the first partial quantum circuit PT1 may be replaced with a ninth CNOT gate CN09 connected to the qubit line of the third auxiliary qubit AQ03 and controlled by the qubit line of the first qubit |Ψ₁>, a tenth CNOT gate CN10 connected to the qubit line of the third auxiliary qubit AQ03 and controlled by the qubit line of the fourth qubit |Ψ₄> subsequent to the ninth CNOT gate CN09, an R(θ₅) gate G07 connected to the qubit line of the first qubit |Ψ₁> subsequent to the tenth CNOT gate CN10, an R(θ₅) gate G08 connected to the qubit line of the fourth qubit |Ψ₄> in parallel with the R(θ₅) gate G07 and subsequent to the tenth CNOT gate CN10, an R(−θ₅) gate G09 connected to the qubit line of the third auxiliary qubit AQ03 in parallel with the R(θ₅) gate G07 and the R(θ₅) gate G08 and subsequent to the tenth CNOT gate CN10, an eleventh CNOT gate CN11 connected to the qubit line of the third auxiliary qubit AQ03 and controlled by the qubit line of the first qubit |Ψ₁> subsequent to the R(θ₅) gate G07, the R(θ₅) gate G08, and the R(−θ₅) gate G09, and a twelfth CNOT gate CN12 connected to the qubit line of the third auxiliary qubit AQ03 and controlled by the qubit line of the fourth qubit |Ψ₄> subsequent to the eleventh CNOT gate CN11.

Illustratively, the first partial quantum circuit PT1 may output operation results of the first qubit |Ψ₁>, the second qubit |Ψ₂>, the third qubit |Ψ₃>, and the fourth qubit |Ψ₄> as a first intermediate qubit IQ1, a second intermediate qubit IQ2, a third intermediate qubit IQ3, and a fourth intermediate qubit IQ4, respectively.

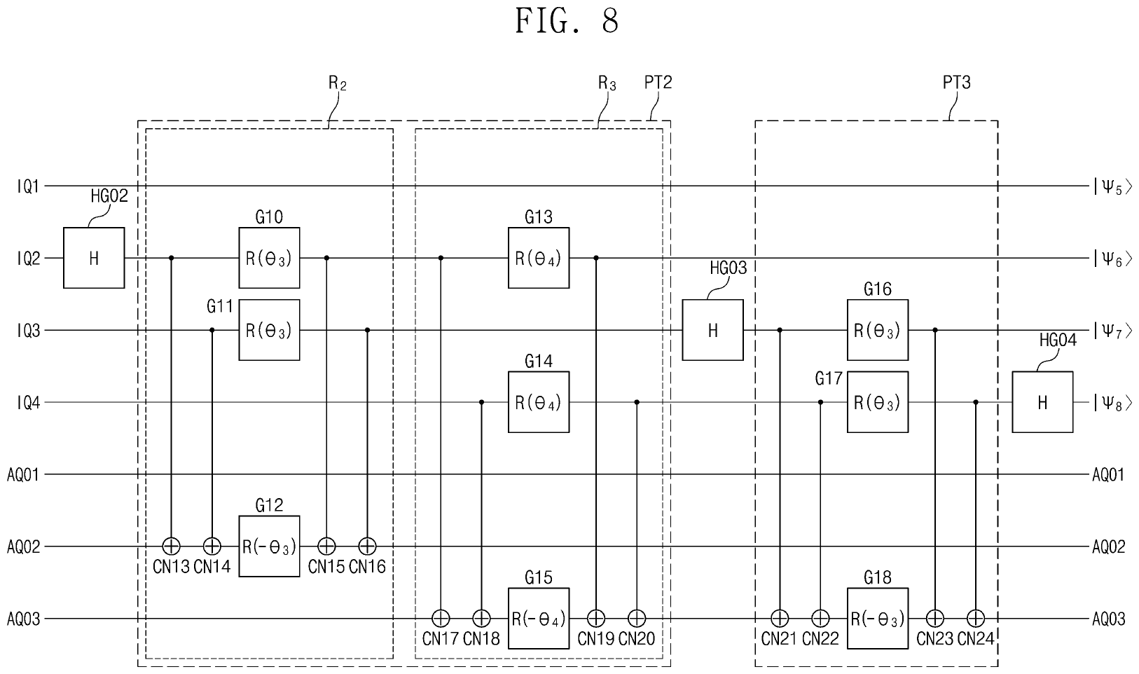

FIG. 8 illustrates examples of the second partial quantum circuit PT2 and the third partial quantum circuit PT3 of FIG. 6. Referring to FIGS. 6 and 8, the CR₂ gate (the controlled gate filled with R₂) of the second partial quantum circuit PT2 may be replaced with a thirteenth CNOT gate CN13 connected to the qubit line of the second auxiliary qubit AQ02 and controlled by a qubit line of the second intermediate qubit IQ2, a fourteenth CNOT gate CN14 connected to the qubit line of the second auxiliary qubit AQ02 and controlled by a qubit line of the third intermediate qubit IQ3 subsequent to the thirteenth CNOT gate CN13, an R(θ₃) gate G10 connected to the qubit line of the second intermediate qubit IQ2 subsequent to the fourteenth CNOT gate CN14, an R(θ₃) gate G11 connected to the qubit line of the third intermediate qubit IQ3 in parallel with the R(θ₃) gate G10 and subsequent to the fourteenth CNOT gate CN14, an R(−θ₃) gate G12 connected to the qubit line of the second auxiliary qubit AQ02 in parallel with the R(θ₃) gate G10 and the R(θ₃) gate G11 and subsequent to the fourteenth CNOT gate CN14, a fifteenth CNOT gate CN15 connected to the qubit line of the second auxiliary qubit AQ02 and controlled by the qubit line of the second intermediate qubit IQ2 subsequent to the R(θ₃) gate G10, the R(θ₃) gate G11, and R(−θ₃) gate G12, and a sixteenth CNOT gate CN16 connected to the qubit line of the second auxiliary qubit AQ02 and controlled by the qubit line of the third intermediate qubit IQ3 subsequent to the fifteenth CNOT gate CN15.

The CR₃ gate (the controlled gate filled with R₃) of the second partial quantum circuit PT2 may be replaced with a seventeenth CNOT gate CN17 connected to the qubit line of the third auxiliary qubit AQ03 and controlled by the qubit line of the second intermediate qubit IQ2, an eighteenth CNOT gate CN18 connected to the qubit line of the third auxiliary qubit AQ03 and controlled by the qubit line of the fourth intermediate qubit IQ4 subsequent to the seventeenth CNOT gate CN17, an R(θ₄) gate G13 connected to the qubit line of the second intermediate qubit IQ2 subsequent to the eighteenth CNOT gate CN18, an R(θ₄) gate G14 connected to the qubit line of the fourth intermediate qubit IQ4 in parallel with the R(θ₄) gate G13 and subsequent to the eighteenth CNOT gate CN18, an R(−θ₄) gate G15 connected to the qubit line of the third auxiliary qubit AQ03 in parallel with the R(θ₄) gate G13 and the R(θ₄) gate G14 and subsequent to the eighteenth CNOT gate CN18, a nineteenth CNOT gate CN19 connected to the qubit line of the third auxiliary qubit AQ03 and controlled by the qubit line of the second intermediate qubit IQ2 subsequent to the R(θ₄) gate G13, the R(θ₄) gate G14, and the R(−θ₄) gate G15, and a twentieth CNOT gate CN20 connected to the qubit line of the third auxiliary qubit AQ03 and controlled by the qubit line of the fourth intermediate qubit IQ4 subsequent to the nineteenth CNOT gate CN19.

The third partial quantum circuit PT3 may be replaced with a twenty first CNOT gate CN21 connected to the qubit line of the third auxiliary qubit AQ03 and controlled by the qubit line of the third intermediate qubit IQ3, a twenty-second CNOT gate CN22 connected to the qubit line of the third auxiliary qubit AQ03 and controlled by the qubit line of the fourth intermediate qubit IQ4 subsequent to the twenty first CNOT gate CN21, an R(θ₃) gate G16 connected to the qubit line of the third intermediate qubit IQ3 subsequent to the twenty-second CNOT gate CN22, an R(θ₃) gate G17 connected to the qubit line of the fourth intermediate qubit IQ4 in parallel with the R(θ₃) gate G16 and subsequent to the twenty-second CNOT gate CN22, an R(−θ₃) gate G18 connected to the qubit line of the third auxiliary qubit AQ03 in parallel with the R(θ₃) gate G16 and the R(θ₃) gate G17 and subsequent to the twenty-second CNOT gate CN22, a twenty-third CNOT gate CN23 connected to the qubit line of the third auxiliary qubit AQ03 and controlled by the qubit line of the third intermediate qubit IQ3 subsequent to the R(θ₃) gate G16, the R(θ₃) gate G17, and the R(−θ₃) gate G18, and a twenty-fourth CNOT gate CN24 connected to the qubit line of the third auxiliary qubit AQ03 and controlled by the qubit line of the fourth intermediate qubit IQ4 subsequent to the twenty-third CNOT gate CN23.

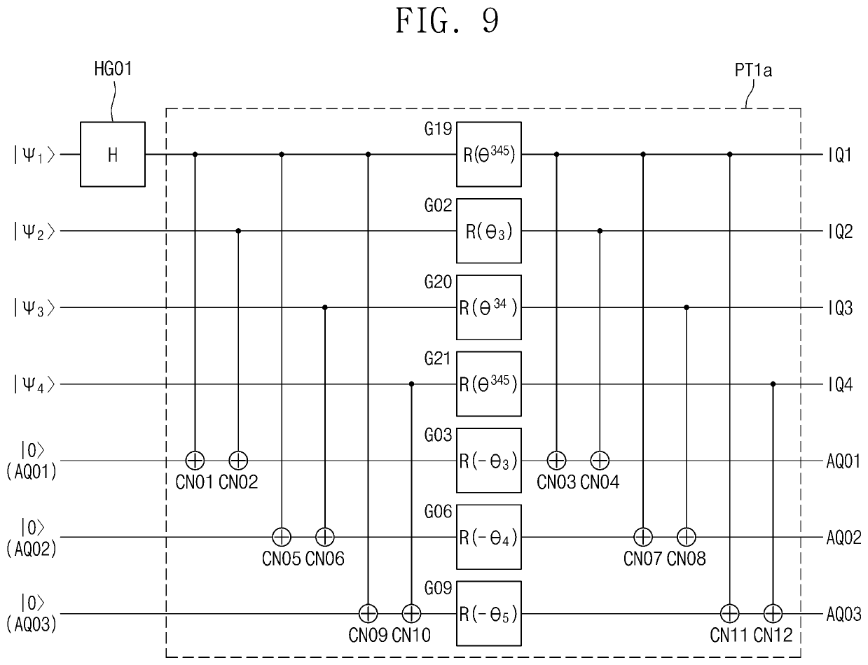

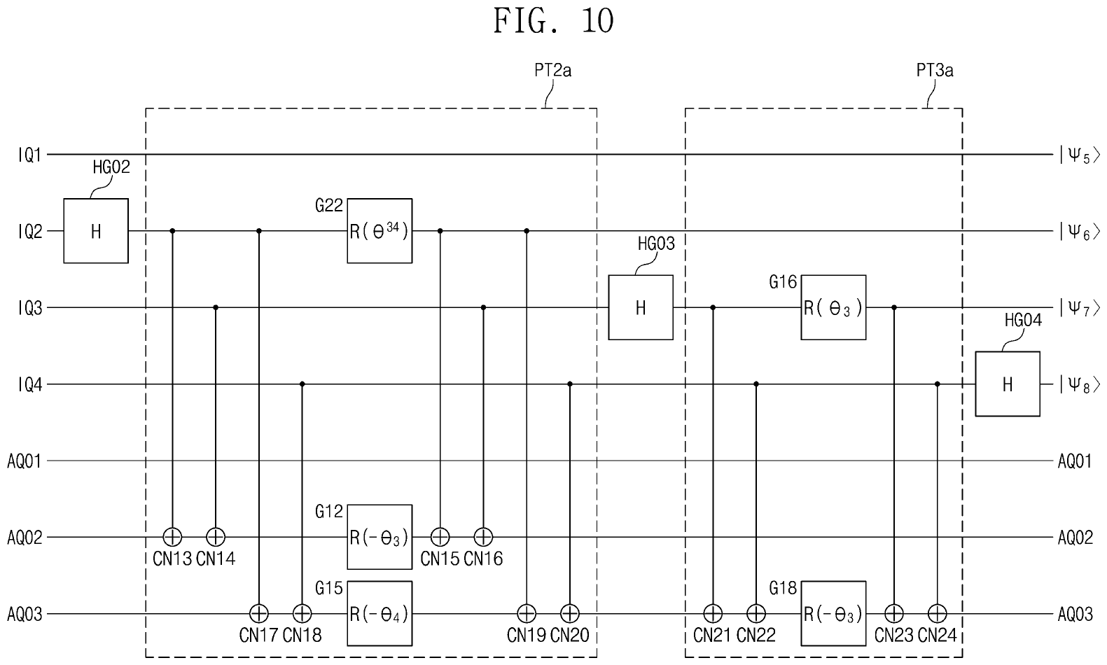

FIGS. 9 and 10 illustrate examples of a first partial quantum circuit PT1a, a second partial quantum circuit PT2a, and a third partial quantum circuit PT3a in which some of gates of the first partial quantum circuit PT1, the second partial quantum circuit PT2, and the third partial quantum circuit PT3 of FIGS. 7 and 8 are combined. Referring to FIGS. 7, 8, 9, and 10, the fifth CNOT gate CN05 and the sixth CNOT gate CN06 of the first partial quantum circuit PT1 of FIG. 7 may follow the first CNOT gate CN01 and the second CNOT gate CN02 and may be moved to a position ahead of the R(θₙ₊₁) gates to form the first partial quantum circuit PT1a of FIG. 9.

The ninth CNOT gate CN09 and the tenth CNOT gate CN10 of the first partial quantum circuit PT1 of FIG. 7 may follow the fifth CNOT gate CN05 and the sixth CNOT gate CN06 and may be moved to a position ahead of the R(θₙ₊₁) gates to form the first partial quantum circuit PT1a of FIG. 9.

The R(θ₃) gate G01 of the CR₂ gate (the controlled gate filled with R₂) of the first partial quantum circuit PT1 in FIG. 7 may be combined with the R(θ₄) gate G04 of the CR₃ gate (the controlled gate filled with R₃) of the first partial quantum circuit PT1 and the R(θ₅) gate G07 of the CR₄ gate (the controlled gate filled with R₄) of the first partial quantum circuit PT1 to form an R(θ³⁴⁵) gate G19 of the first partial quantum circuit PT1a of FIG. 9. For example, the ‘θ³⁴⁵’ may be ‘θ₃+θ₄+θ₅’.

The R(θ₄) gate G05 of the CR₃ gate (the controlled gate filled with R₃) of the first partial quantum circuit PT1 of FIG. 7 may be combined with the R(θ₃) gate G11 of the CR₂ gate (the controlled gate filled with R₂) of the second partial quantum circuit PT2 of FIG. 8 to form an R(θ³⁴) gate G20 of the first partial quantum circuit PT1a of FIG. 9. For example, the ‘θ³⁴’ may be ‘θ₃+θ₄’. The R(θ₃) gate G11 of the CR₂ gate (the controlled gate filled with R₂) of the second partial quantum circuit PT2 in FIG. 8 may be removed from the CR₂ gate (the controlled gate filled with R₂) of the second partial quantum circuit PT2 of FIG. 8 to form the second partial quantum circuit PT2a of FIG. 10.

The R(θ₅) gate G08 of the CR₄ gate (the controlled gate filled with R₄) of the first partial quantum circuit PT1 of FIG. 7 may be combined with the R(θ₃) gate G11 of the CR₃ gate (the controlled gate filled with R₃) of the second partial quantum circuit PT2 of FIG. 8 and the R(θ₃) gate G17 of the third partial quantum circuit PT3 of FIG. 8 to form an R(θ³⁴⁵) gate G21 of the first partial quantum circuit PT1a of FIG. 9. The R(θ₃) gate G11 of the CR₃ gate (the controlled gate filled with R₃) of the second partial quantum circuit PT2 in FIG. 8 may be removed from the CR₃ gate (the controlled gate filled with R₃) of the second partial quantum circuit PT2 of FIG. 8 to form the second partial quantum circuit PT2a of FIG. 10. The R(θ³⁴⁵) gate G21 of the first partial quantum circuit PT1a of FIG. 9 may be removed from the first partial quantum circuit PT1a of FIG. 9 to form the third partial quantum circuit PT3a of FIG. 10.

The third CNOT gate CN03 and the fourth CNOT gate CN04 of the first partial quantum circuit PT1 in FIG. 7 may follow the R(θₙ₊₁) gates and may be moved to a position ahead of the eleventh CNOT gate CN11 and the twelfth CNOT gate CN12 to form the first partial quantum circuit PT1a of FIG. 9.

The seventh CNOT gate CN07 and the eighth CNOT gate CN08 of the first partial quantum circuit PT1 in FIG. 7 may follow the third CNOT gate CN03 and the fourth CNOT gate CN04 and may be moved to a position ahead of the eleventh CNOT gate CN11 and the twelfth CNOT gate CN12 to form the first partial quantum circuit PT1a of FIG. 9.

The seventeenth CNOT gate CN17 and the eighteenth CNOT gate CN18 of the second partial quantum circuit PT2 of FIG. 8 may follow the thirteenth CNOT gate CN13 and the fourteenth CNOT gate CN14 and may be moved to a position ahead of the R(θₙ₊₁) gate to form the second partial quantum circuit PT2a of FIG. 10.

The R(θ₃) gate G10 of the CR₂ gate (the controlled gate filled with R₂) of the second partial quantum circuit PT2 of FIG. 8 may be combined with the R(θ₄) gate G13 of the CR₃ gate (the controlled gate filled with R₃) of the second partial quantum circuit PT2 of FIG. 8 to form an R(θ³⁴) gate G22 of the second partial quantum circuit PT2a of FIG. 10. The R(θ₄) gate G13 of the CR₃ gate (the controlled gate filled with R₃) of the second partial quantum circuit PT2 in FIG. 8 may be removed from the CR₃ gate (the controlled gate filled with R₃) of the second partial quantum circuit PT2 of FIG. 8 to form the second partial quantum circuit PT2a of FIG. 10.

The fifteenth CNOT gate CN15 and the sixteenth CNOT gate CN16 of the second partial quantum circuit PT2 in FIG. 8 may follow the R(θₙ₊₁) gate and may be moved to a position ahead of the nineteenth CNOT gate CN19 and the twentieth CNOT gate CN20 to form the second partial quantum circuit PT2a of FIG. 10.

As described with reference to FIGS. 9 and 10, the CRₙ gates may be replaced with R(θₙ₊₁) gates of depth 3 by adding the first auxiliary qubit AQ01, the second auxiliary qubit AQ02, and the third auxiliary qubit AQ03 and converting the first quantum circuit QC1 into the third quantum circuit QC3. Accordingly, the depth of the R(θₙ₊₁) gates may be further reduced compared to the second quantum circuit QC2.

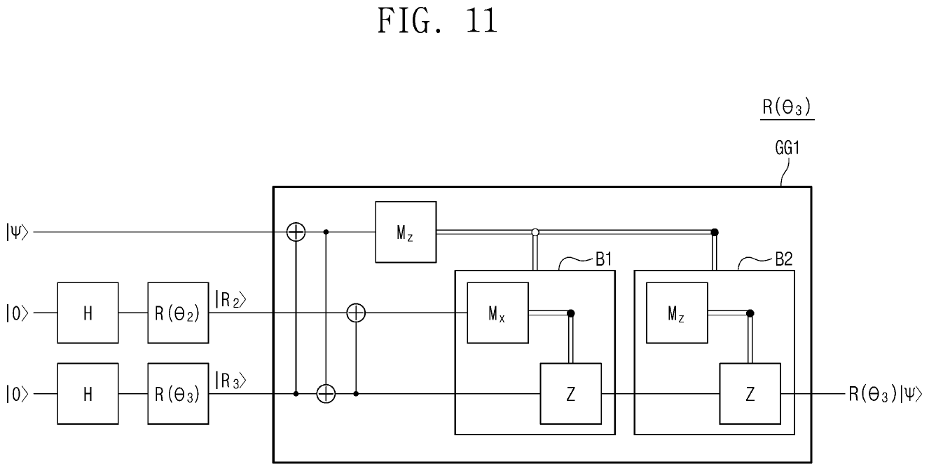

FIG. 11 illustrates an equivalent circuit of an R(θ₃) gate. Referring to FIG. 11, the equivalent circuit of the R(θ₃) gate may receive an input qubit |Ψ> and two zero qubits |0> used as auxiliary qubits as inputs.

The qubit line of the input qubit |Ψ> may be connected to a first gate group GG1. The qubit line of one zero qubit |0> may be connected to the first gate group GG1 through the Hadamard gate ‘H’ and R(θ₂) gate. For example, the output of the R(θ₂) gate may be |R₂>. The qubit line of another one zero qubit |0> may be connected to the first gate group GG1 through the Hadamard gate ‘H’ and R(θ₃) gate. For example, the output of the R(θ₃) gate may be |R₃>.

The first gate group GG1 may include a CNOT gate (the controlled gate connected to ⊕) connected to the qubit line of the input qubit |Ψ> and controlled by the qubit line of |R₃>, a CNOT gate (the controlled gate connected to connected to the qubit line of |R₃> and controlled by the qubit line of the input qubit |Ψ>, and a CNOT gate (the controlled gate connected to ⊕) connected to the qubit line of |R₂> and controlled by the qubit line of |R₃>.

The first gate group GG1 may include an M_{z} gate connected to the qubit line of the input qubit |Ψ> subsequent to the CNOT gates, and a first gate block B1 and a second gate block B2 that are connected to the qubit line of |R₂> and the qubit line of |R₃> and controlled by a measurement result of the M_{z} gate subsequent to the CNOT gates.

The first gate block B1 may include an Mₓ gate connected to the qubit line of |R₂>, and a Z gate that is connected to the qubit line of |R₃> and operates depending on a measurement result of the Mₓ gate.

The second gate block B2 may include an M2 gate connected to the qubit line of |R₂>, and a Z gate that is connected to the qubit line of |R₃> subsequent to the Z gate of the first gate block B1 and operates depending on a measurement result of the M_{z} gate of the second gate block B2.

The output of the Z gate of the second gate block B2 may be an output qubit R(θ₃)Ψ>. Illustratively, as with the R(θ₃) gate, the equivalent circuit of the R(θ₃) gate internally exhausts the qubit lines (or auxiliary qubits) of the two auxiliary qubits, and may be connected to the qubit line of one output qubit R(θ₃)Ψ>.

According to the equivalent circuit of the R(θ₃) gate in FIG. 11, the R(θ₃) gate connected to the qubit line of the input qubit |Ψ> may be replaced with the R(θ₂) gate and the R(θ₃) gate that are connected to two auxiliary qubits. That is, the R(θₙ₊₁) gate may be moved to the qubit lines of the auxiliary qubits.

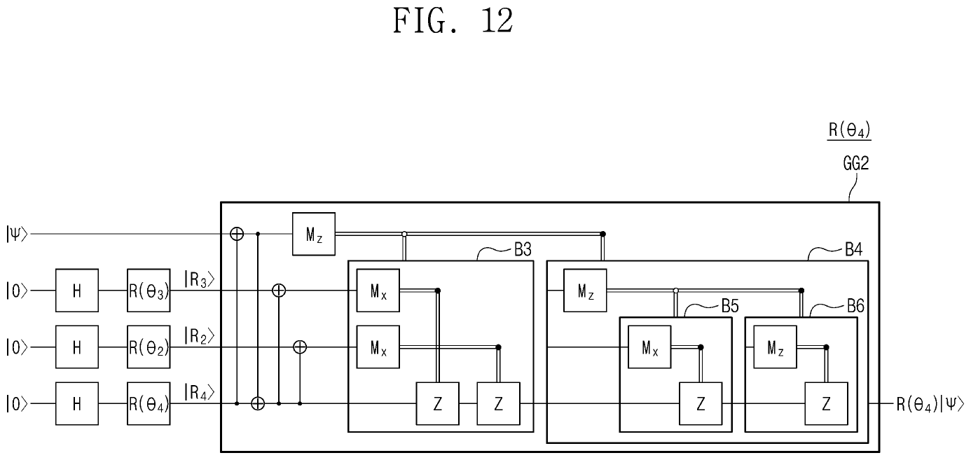

FIG. 12 illustrates an equivalent circuit of an R(θ₄) gate. Referring to FIG. 12, the equivalent circuit of the R(θ₄) gate may receive the input qubit |Ψ> and three zero qubits |0> used as auxiliary qubits as inputs.

The qubit line of the input qubit |Ψ> may be connected to a second gate group GG2. The qubit line of one zero qubit |0> may be connected to the second gate group GG2 through the Hadamard gate ‘H’ and R(θ₃) gate. For example, the output of the R(θ₃) gate may be |R₃>. The qubit line of another one zero qubit |0> may be connected to the second gate group GG2 through the Hadamard gate ‘H’ and R(θ₂) gate. For example, the output of the R(θ₂) gate may be |R₂>. The qubit line of another one zero qubit |0> may be connected to the second gate group GG2 through the Hadamard gate ‘H’ and R(θ₄) gate. For example, the output of the R(θ₄) gate may be |R₄>.

The second gate group GG2 may include a CNOT gate (the controlled gate connected to ⊕̅) connected to the qubit line of the input qubit |Ψ> and controlled by the qubit line of |R₄>, a CNOT gate (the controlled gate connected to ⊕̅) connected to the qubit line of |R₄> and controlled by the qubit line of the input qubit |Ψ>, a CNOT gate (the controlled gate connected to ⊕̅) connected to the qubit line of |R₃> and controlled by the qubit line of |R₄>, and a CNOT gate (the controlled gate connected to connected to ⊕̅) the qubit line of |R₂> and controlled by the qubit line of |R₄>.

The second gate group GG2 may include an M_{z} gate connected to the qubit line of the input qubit |Ψ> subsequent to the CNOT gates, and a third gate block B3 and a fourth gate block B4 that are connected to the qubit line of |R₃>, the qubit line of |R₂>, and the qubit line of |R₄> and are controlled by a measurement result of the M_{z} gate subsequent to the CNOT gates.

The third gate block B3 may include an Mₓ gate connected to the qubit line of |R₃>, an Mₓ gate connected to the qubit line of |R₂>, a Z gate that is connected to the qubit line of |R₄> and operates depending on a measurement result of the Mₓ gate of the third gate block B3 connected to the qubit line of |R₃>, and a Z gate that is connected to the qubit line of |R₄> subsequent to the Z gate of the third gate block B3 and operates depending on a measurement result of the Mₓ gate of the third gate block B3 connected to the qubit line of |R₂>.

The fourth gate block B4 may include an M_{z} gate connected to the qubit line of |R₃>, and a fifth gate block B5 and a sixth gate block B6 that are connected to the qubit line of |R₂> and the qubit line of |R₄> subsequent to the third gate block B3.

The fifth gate block B5 may include an Mₓ gate connected to the qubit line of |R₂>, and a Z gate that is connected to the qubit line of |R₄> and operates depending on a measurement result of the Mₓ gate of the fifth gate block B5.

The sixth gate block B6 may include an M_{z} gate connected to the qubit line of |R₂>, and a Z gate that is connected to the qubit line of |R₄> subsequent to the Z gate of the fifth gate block B5 and operates depending on a measurement result of the M_{z} gate of the sixth gate block B6.

The output of the Z gate of the sixth gate block B6 may be an output qubit R(θ₄)|Ψ>. Illustratively, as with the R(θ₄) gate, the equivalent circuit of the R(θ₄) gate internally exhausts the qubit lines (or auxiliary qubits) of the three auxiliary qubits, and may be connected to the qubit line of one output qubit R(θ₄)|Ψ>.

According to the equivalent circuit of the R(θ₄) gate in FIG. 12, the R(θ₄) gate connected to the qubit line of the input qubit |Ψ> may be replaced with the R(θ₃) gate, the R(θ₂) gate, and the R(θ₄) gate that are connected to the three auxiliary qubits. That is, the R(θₙ₊₁) gate may be moved to the qubit lines of the auxiliary qubits.

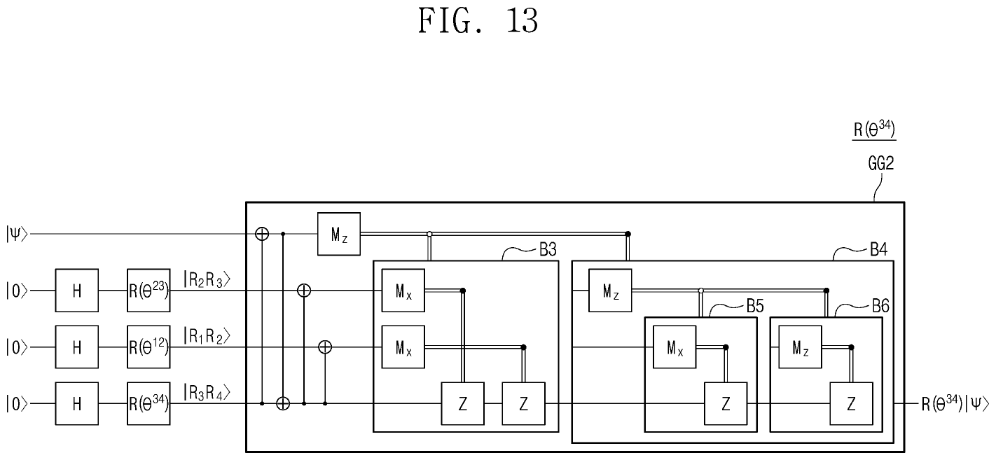

FIG. 13 illustrates an equivalent circuit of an R(θ³⁴) gate. Referring to FIG. 12, the equivalent circuit of the R(θ³⁴) gate may receive the input qubit |Ψ> and three zero qubits |0> used as auxiliary qubits as inputs.

The qubit line of the input qubit |Ψ> may be connected to the second gate group GG2. The qubit line of one zero qubit |0> may be connected to the second gate group GG2 through the Hadamard gate ‘H’ and R(θ²³) gate. For example, the output of the R(θ²³) gate may be |R₂R₃>. The qubit line of another one zero qubit |0> may be connected to the second gate group GG2 through the Hadamard gate ‘H’ and the R(θ¹²) gate. For example, the output of the R(θ¹²) gate may be |R₁R₂>. The qubit line of another one zero qubit |0> may be connected to the second gate group GG2 through the Hadamard gate ‘H’ and the R(θ³⁴) gate. For example, the output of the R(θ³⁴) gate may be |R₃R₄>.

The second gate group GG2 may be configured the same as the second gate group GG2 described with reference to FIG. 11 except that it receives |R²³>, |R¹²>, and |R³⁴> from the qubit lines of the auxiliary qubits, and may operate in the same way. Thus, additional description will be omitted to avoid redundancy.

The output of the Z gate of the sixth gate block B6 may be the output qubit R(θ³⁴)|Ψ>. Illustratively, as with the R(θ³⁴) gate, the equivalent circuit of the R(θ³⁴) gate internally exhausts the qubit lines (or auxiliary qubits) of the three auxiliary qubits, and may be connected to the qubit line of one output qubit R(θ³⁴)|Ψ>.

According to the equivalent circuit of the R(θ³⁴) gate in FIG. 13, the R(θ³⁴) gate connected to the qubit line of the input qubit |Ψ> may be replaced with the R(θ²³) gate, the R(θ¹²) gate, and the R(θ³⁴) gate that are connected to the three auxiliary qubits. That is, the R(θₙ₊₁) gate may be moved to the qubit lines of the auxiliary qubits.

By way of example, ‘−θ’ is not described in detail, but it will be understood by those skilled in the art that the description of ‘0’ may be equally applied to ‘−θ’. For example, when the replacement target is the R(−θ₃) gate, the R(−θ₂) gate and the R(−θ₃) gate may be provided to the qubit lines of the auxiliary qubits (refer to FIG. 11) instead of the R(θ₂) gate and the R(θ₃) gate.

When the replacement target is the R(−θ₄) gate, the R(−θ₃) gate, the R(−θ₂) gate, and the R(−θ₄) gate may be provided to the qubit lines of the auxiliary qubits (refer to FIG. 12) instead of the R(θ₃) gate, the R(θ₂) gate, and the R(θ₄) gate. When the replacement target is the R(−θ³⁴) gate, the R(−θ²³) gate, the R(−θ¹²) gate, and the R(−θ³⁴) gate may be provided to the qubit lines of the auxiliary qubits (refer to FIG. 13) instead of the R(θ²³) gate, the R(θ¹²) gate, and the R(θ³⁴) gate.

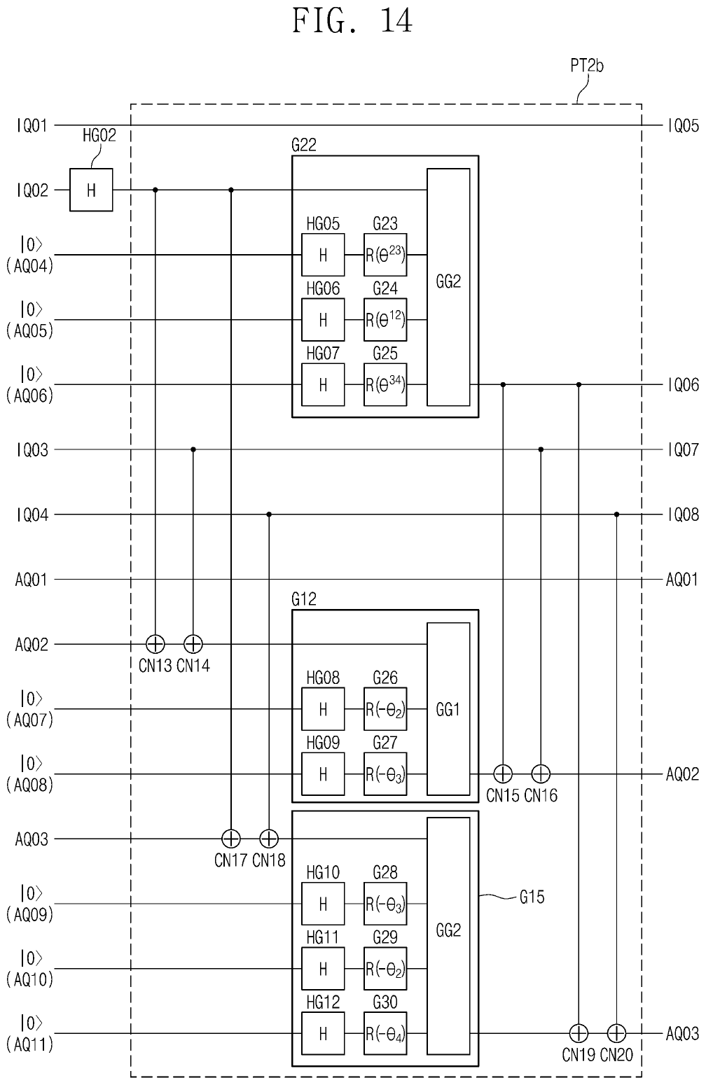

FIG. 14 illustrates examples of applying equivalent circuits of FIGS. 11, 12, and 13 to the second partial quantum circuit PT2a of FIG. 10. Referring to FIGS. 10 and 14, the R(θ³⁴) gate G22 may be replaced with the equivalent circuit of the R(θ³⁴) gate described with reference to FIG. 13. The R(−θ₃) gate G12 may be replaced with the equivalent circuit of the R(−θ₃) gate described with reference to FIG. 11. The R(−θ₄) gate G15 may be replaced with the equivalent circuit of the R(−θ₄) gate described with reference to FIG. 12.

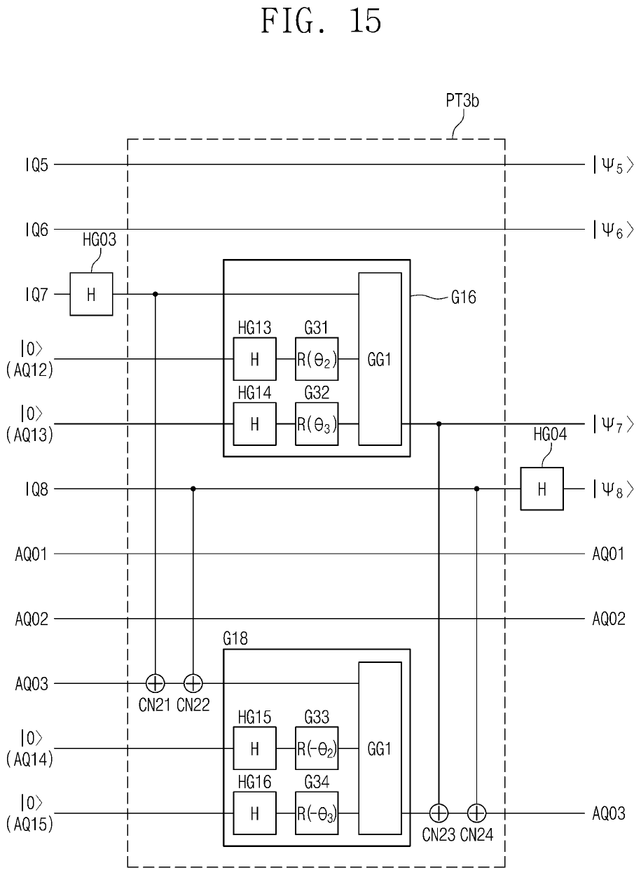

FIG. 15 illustrates an example of applying an equivalent circuit of FIG. 11 to the third partial quantum circuit PT3a of FIG. 10. Referring to FIGS. 10 and 15, the R(θ₃) gate G16 may be replaced with the equivalent circuit of the R(θ₃) gate described with reference to FIG. 11. The R(−θ₃) gate G18 may be replaced with the equivalent circuit of the R(−θ₃) gate described with reference to FIG. 11.

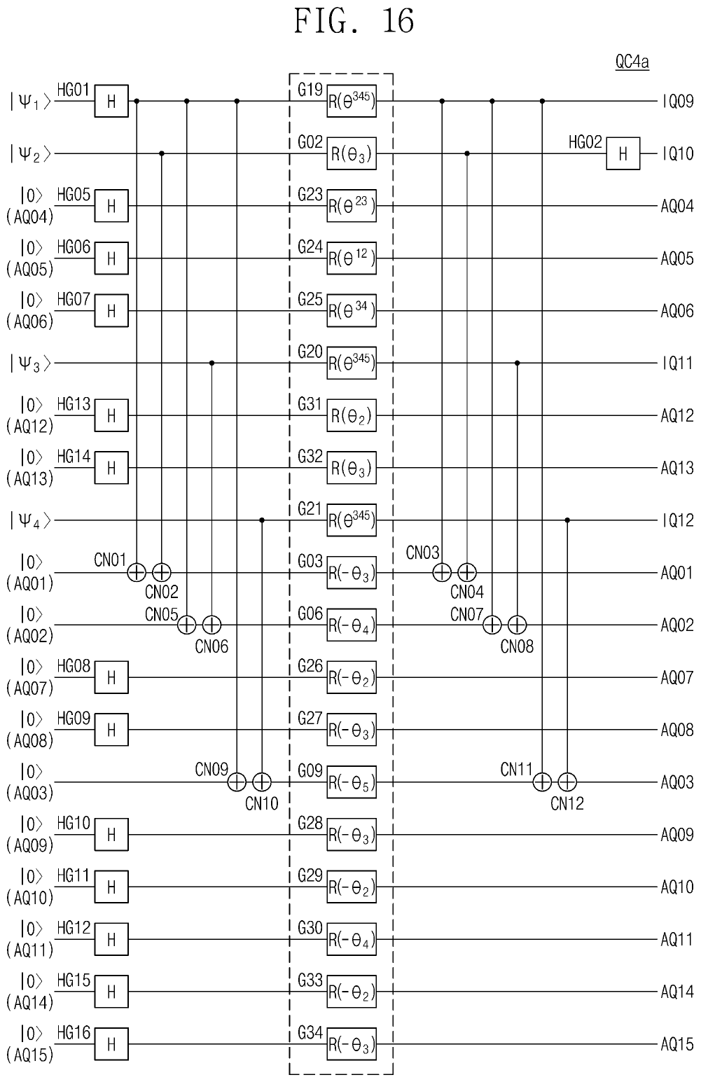

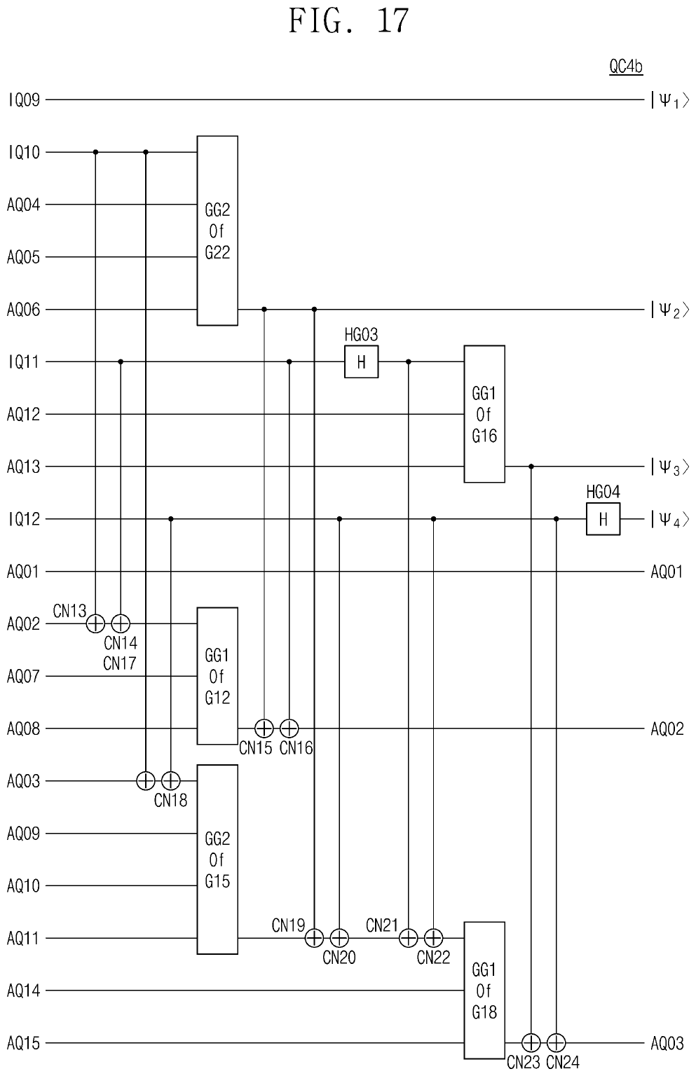

When the replacement of FIGS. 14 and 15 is performed on the third quantum circuit QC3 of FIG. 6, the third quantum circuit QC3 of FIG. 6 may be modified a 4a quantum circuit QC4a and a 4b quantum circuit QC4b of FIGS. 16 and 17.

FIGS. 16 and 17 illustrate the modified 4a quantum circuit QC4a and the modified 4b quantum circuit QC4b, respectively. Referring to FIGS. 16 and 17, the 4a quantum circuit QC4a may receive the first qubit |Ψ₁>, the second qubit |Ψ₂>, the third qubit |Ψ₃>, the fourth qubit |Ψ₄>, the first auxiliary qubit AQ01, the second auxiliary qubit AQ02, the third auxiliary qubit AQ03, a fourth auxiliary qubit AQ04, a fifth auxiliary qubit AQ05, a sixth auxiliary qubit AQ06, a seventh auxiliary qubit AQ07, an eighth auxiliary qubit AQ08, a ninth auxiliary qubit AQ09, a tenth auxiliary qubit AQ10, an eleventh auxiliary qubit AQ11, a twelfth auxiliary qubit AQ12, a thirteenth auxiliary qubit AQ13, a fourteenth auxiliary qubit AQ14, and a fifteenth auxiliary qubit AQ15, as input qubits.

The first qubit |Ψ₁>, the second qubit |Ψ₂>, the third qubit |Ψ₃>, and the fourth qubit |Ψ₄> may be qubits on which the Fourier transform is performed. The first auxiliary qubit AQ01, the second auxiliary qubit AQ02, and the third auxiliary qubit AQ03 may be auxiliary qubits (e.g., auxiliary qubits of a first type) used to convert the CRₙ gates to the R(θₙ₊₁) gates as described with reference to FIGS. 5, 6, 7, and 8.

The fourth auxiliary qubit AQ04, the fifth auxiliary qubit AQ05, the sixth auxiliary qubit AQ06, the seventh auxiliary qubit AQ07, the eighth auxiliary qubit AQ08, the ninth auxiliary qubit AQ09, the tenth auxiliary qubit AQ10, the eleventh auxiliary qubit AQ11, the twelfth auxiliary qubit AQ12, the thirteenth auxiliary qubit AQ13, the fourteenth auxiliary qubit AQ14, and the fifteenth auxiliary qubit AQ15 may be auxiliary qubits (e.g., auxiliary qubits of a second type) used to move some of the R(θₙ₊₁) gates to the fourth auxiliary qubit AQ04, the fifth auxiliary qubit AQ05, the sixth auxiliary qubit AQ06, the seventh auxiliary qubit AQ07, the eighth auxiliary qubit AQ08, the ninth auxiliary qubit AQ09, the tenth auxiliary qubit AQ10, the eleventh auxiliary qubit AQ11, the twelfth auxiliary qubit AQ12, the thirteenth auxiliary qubit AQ13, the fourteenth auxiliary qubit AQ14, and the fifteenth auxiliary qubit AQ15, as described with reference to FIGS. 11, 12, 13, 14, and 15.

The R(θₙ₊₁) gates of FIGS. 6, 7, and 8 may be modified into parallel R(θ) gates with a depth of 1 in a gate layer RL. For example, the gate layer RL may include the R(θ³⁴⁵) gate G19 connected to the qubit line of the first qubit |Ψ₁>, the R(θ₃) gate G02 connected to the qubit line of the second qubit |Ψ₂>, an R(θ²³) gate G23 connected to the qubit line of the fourth auxiliary qubit AQ04, an R(θ¹²) gate G24 connected to the qubit line of the fifth auxiliary qubit AQ05, an R(θ³⁴) gate G25 connected to the qubit line of sixth auxiliary qubit AQ06, the R(θ³⁴⁵) gate G20 connected to the qubit line of the third qubit |Ψ₃>, an R(θ₂) gate G31 connected to the qubit line of the twelfth auxiliary qubit AQ12, an R(θ₃) gate G32 connected to the qubit line of the thirteenth auxiliary qubit AQ13, the R(θ³⁴⁵) gate G21 connected to the qubit line of the fourth qubit |Ψ₄>, the R(−θ₃) gate G03 connected to the qubit line of the first auxiliary qubit AQ01, the R(−θ₄) gate G06 connected to the qubit line of the second auxiliary qubit AQ02, an R(−θ₂) gate G26 connected to the qubit line of the seventh auxiliary qubit AQ07, an R(−θ₃) gate G27 connected to the qubit line of the eighth auxiliary qubit AQ08, the R(−θ₅) gate G09 connected to the qubit line of the third auxiliary qubit AQ03, an R(−θ₃) gate G28 connected to the qubit line of the ninth auxiliary qubit AQ09, the R(−θ₃) gate G28 connected to the qubit line of the tenth auxiliary qubit AQ10, the R(−θ₄) gate G11 connected to the qubit line of the eleventh auxiliary qubit AQ11, an R(−θ₂) gate G33 connected to the qubit line of the fourteenth auxiliary qubit AQ14, and an R(−θ₃) gate G34 connected to the qubit line of the fifteenth auxiliary qubit AQ15.

The 4b quantum circuit QC4b may not have an R(θ) gate. The 4b quantum circuit QC4b may include the second gate group GG2 of a twenty-second gate G22, the first gate group GG1 of a twelfth gate G12, the second gate group GG2 of a fifteenth gate G15, the first gate group GG1 of a sixteenth gate G16, and the first gate group GG1 of an eighteenth gate G18.

The 4a quantum circuit QC4a and the 4b quantum circuit QC4b may be quantum Fourier transform circuits.

The gate layer RL may complete the operations of all CRₙ gates of the Fourier transform of the first quantum circuit QC1 of FIG. 1 during the computation time of one R(θ) gate. Accordingly, the speed at which the 4a quantum circuit QC4a and the 4b quantum circuit QC4b perform Fourier transform may be improved.

FIG. 18 illustrates an example of how to produce a quantum Fourier transform circuit. Illustratively, a method of FIG. 18 may be performed by a digital computer configured to generate a quantum algorithm. Referring to FIG. 18, in operation S210, the digital computer may replace some circuits of the quantum Fourier transform circuit. For example, the digital computer may replace some circuits of the quantum Fourier transform circuit, according to the method described with reference to FIGS. 4, 5, 6, 7, 8, 9, 10, 14, and 15.

In operation S220, the digital computer may integrate R(θ) gates into one gate layer RL. In operation S230, the digital computer may produce the quantum Fourier transform circuit by performing a quantum circuit transformation.

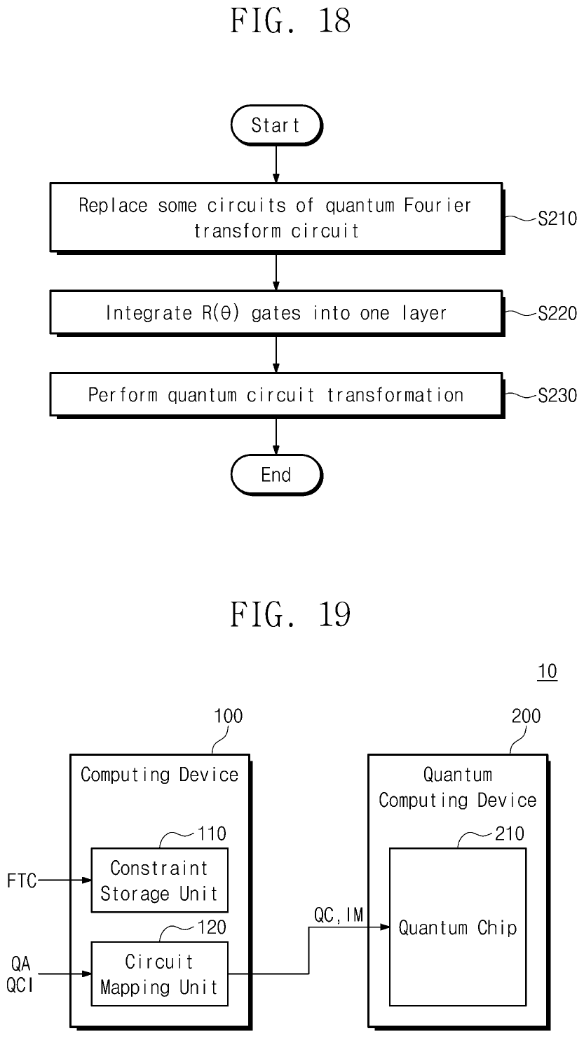

FIG. 19 illustrates a quantum system 10 according to an embodiment of the present disclosure. Referring to FIG. 19, the quantum system 10 may include a computing device 100 and a quantum computing device 200.

The computing device 100 may perform quantum circuit mapping based on a fault-tolerant constraint (FTC), quantum algorithm information (QA) (or quantum protocol information), and quantum chip information (QCI), thereby generating a quantum circuit QC and an initial qubit mapping IM. The initial qubit mapping IM may include qubit positions on a quantum chip 210 and mapping information of qubits for an operation. The computing device 100 may include a constraint storage unit 110 and a circuit mapping unit 120.

The constraint storage unit 110 is configured to store the fault-tolerance constraint (FTC). For example, the fault-tolerance constraint (FTC) may be transferred to the constraint storage unit 110 of the computing device 100 by a user or by an external computing device. The fault-tolerant constraint (FTC) may support the circuit mapping unit 120 to map a fault-tolerant quantum circuit.

The circuit mapping unit 120 may generate the quantum circuit QC and the initial qubit mapping IM based on the fault-tolerant constraint (FTC), the quantum algorithm information (QA), and the quantum chip information (QCI).

The quantum computing device 200 may perform quantum computing. The quantum computing device 200 may be implemented based on semiconductors such as superconductors, quantum dots, etc. The quantum computing device 200 may include the quantum chip 210 including a plurality of qubits. For example, the quantum chip 210 may include the 4a quantum circuit QC4a and the 4b quantum circuit QC4b.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

In the above embodiments, components according to embodiments of the inventive concept are described by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. In addition, the blocks may include circuits composed of semiconductor devices in the IC or circuits registered as an IP (Intellectual Property).

According to an embodiment of the present disclosure, the quantum Fourier transform circuit may be implemented with an Rₙ gate having a depth of 1. Accordingly, a quantum Fourier transform circuit with a shorter computation time and a method for mapping the quantum Fourier transform circuit are provided.

The above descriptions are specific embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A quantum circuit comprising:
input qubit lines;
auxiliary qubit lines; and
an R(θ) gate layer connected to the input qubit lines and the auxiliary qubit lines, and
wherein the R(θ) gate layer is configured to perform a plurality of R(θ) gate operations at once based on input qubits of the input qubit lines and auxiliary qubits of the auxiliary qubit lines, and
wherein the quantum circuit is configured to output Fourier transform results with respect to the input qubits as output qubits, based on a result of the plurality of R(θ) gate operations, without additional R(θ) gate operations.

2. The quantum circuit of claim 1, wherein zero qubits are received as the auxiliary qubits.

3. The quantum circuit of claim 1, wherein the R(θ) gate layer is configured to perform the plurality of R(θ) gate operations on both the input qubits and the auxiliary qubits, respectively.

4. The quantum circuit of claim 1, wherein first auxiliary qubits among the auxiliary qubits are used to convert a CRₙ gate of a quantum Fourier transform circuit to an Rₙ gate.

5. The quantum circuit of claim 4, wherein second auxiliary qubits among the auxiliary qubits are used to move the Rₙ gate located on a specific qubit line among the input qubit lines and first auxiliary qubit lines to some of second auxiliary qubit lines.

6. The quantum circuit of claim 5, further comprising:
a gate group configured to receive the input qubits of the input qubit lines, one qubit of the first auxiliary qubits of the first auxiliary qubit lines, and at least two second auxiliary qubits of at least two of the second auxiliary qubit lines, and to output an operation result qubit corresponding to the one qubit.

7. The quantum circuit of claim 6, wherein the gate group includes:
a first CNOT gate coupled to a qubit line of the one qubit and controlled by a qubit line of one second auxiliary qubit of the at least two second auxiliary qubits;
a second CNOT gate connected to the qubit line of the one second auxiliary qubit and controlled by the qubit line of the one qubit;
a third CNOT gate connected to a qubit line of another second auxiliary qubit of the at least two second auxiliary qubits and controlled by the qubit line of the one second auxiliary qubit;
a first M_{z} gate connected to the one qubit;
an Mₓ gate that operates based on a measurement result of the first M_{z} gate and is connected to the another second auxiliary qubit;
a second M_{z} gate that operates based on the measurement result of the first M_{z} gate and is connected to the another second auxiliary qubit;
a first Z gate that operates based on a measurement result of the Mₓ gate and is connected to the one second auxiliary qubit; and
a second Z gate that operates based on a measurement result of the second M_{z} gate and is connected to the one second auxiliary qubit.

8. The quantum circuit of claim 7, wherein the gate group, a first Hadamard gate connected to the one second auxiliary qubit, an R(θ₃) gate of the gate layer connected to the one second auxiliary qubit, a second Hadamard gate connected to the another second auxiliary qubit, and an R(θ₂) gate of the gate layer connected to the another second auxiliary qubit correspond to an R(θ₃) gate connected to the one qubit.

9. The quantum circuit of claim 6, wherein the gate group includes:
a first CNOT gate coupled to a qubit line of the one qubit and controlled by a qubit line of one second auxiliary qubit of the at least two second auxiliary qubits;
a second CNOT gate connected to the qubit line of the one second auxiliary qubit and controlled by the qubit line of the one qubit;
a third CNOT gate connected to a qubit line of another second auxiliary qubit of the at least two second auxiliary qubits and controlled by the qubit line of the one second auxiliary qubit;
a fourth CNOT gate connected to a qubit line of the other second auxiliary qubit of the at least two second auxiliary qubits and controlled by the qubit line of the one second auxiliary qubit;
a first M_{z} gate connected to the one qubit;
a first Mₓ gate that operates based on a measurement result of the first M_{z} gate and is connected to the another second auxiliary qubit;
a second Mₓ gate that operates based on the measurement result of the first M_{z} gate and is connected to the other second auxiliary qubit;
a first Z gate that operates based on a measurement result of the first Mₓ gate and is connected to the one second auxiliary qubit;
a second Z gate that operates based on a measurement result of the second Mₓ gate and is connected to the one second auxiliary qubit;
a second M_{z} gate that operates based on the measurement result of the first M_{z} gate and is connected to the another second auxiliary qubit;
a third Mₓ gate that operates based on the measurement result of the second M_{z} gate and is connected to the other second auxiliary qubit;
a third Z gate that operates based on a measurement result of the third Mₓ gate and is connected to the one second auxiliary qubit;
a third M_{z} gate that operates based on the measurement result of the second M_{z} gate and is connected to the other second auxiliary qubit; and
a fourth Z gate that operates based on the measurement result of the second M_{z} gate and is connected to the one second auxiliary qubit.

10. The quantum circuit of claim 9, wherein the gate group, a first Hadamard gate connected to the one second auxiliary qubit, an R(θ₄) gate of the gate layer connected to the one second auxiliary qubit, a second Hadamard gate connected to the another second auxiliary qubit, an R(θ₃) gate of the gate layer connected to the another second auxiliary qubit, a third Hadamard gate connected to the other second auxiliary qubit, and an R(θ₂) gate of the gate layer connected to the other second auxiliary qubit correspond to an R(θ₄) gate connected to the one qubit.

11. The quantum circuit of claim 9, wherein the gate group, a first Hadamard gate connected to the one second auxiliary qubit, an R(θ³⁴) gate of the gate layer connected to the one second auxiliary qubit, a second Hadamard gate connected to the another second auxiliary qubit, an R(θ²³) gate of the gate layer connected to the another second auxiliary qubit, a third Hadamard gate connected to the other second auxiliary qubit, and an R(θ¹²) gate of the gate group connected to the other second auxiliary qubit correspond to an R(θ³⁴) gate connected to the one qubit.

12. A method of mapping a quantum Fourier transform circuit, the method comprising:
replacing first circuits with second circuits by adding first auxiliary qubits to the quantum Fourier transform circuit;
integrating R(θ) gates into one layer by adding second auxiliary qubits to the replaced quantum Fourier transform circuit; and
performing a quantum circuit transformation, and
wherein the integrating of into the one layer includes:
generating an R(θ) gate layer that performs a plurality of R(θ) gate operations at once based on input qubits of input qubit lines and auxiliary qubits of second auxiliary qubit lines.

13. The method of claim 12, wherein a depth of the R(θ) gate of the quantum Fourier transform circuit in which the quantum circuit transformation is performed is 1.

14. The method of claim 12, further comprising:
receiving zero qubits as the first auxiliary qubits.

15. The method of claim 12, further comprising:
receiving zero qubits as the second auxiliary qubits.

16. The method of claim 12, further comprising:
outputting operation results of output qubits and the first auxiliary qubits through operations of the quantum Fourier transform circuit in which the quantum circuit transformation is performed.

17. The method of claim 12, further comprising:
exhausting the second auxiliary qubits in operations of the quantum Fourier transform circuit in which the quantum circuit transformation is performed.

18. The method of claim 12, further comprising:
performing the plurality of R(θ) gate operations on all of the input qubits, the first auxiliary qubits, and the second auxiliary qubits, respectively, using the R(θ) gate layer.

19. The method of claim 12, wherein the first circuits include CRₙ gates, and wherein the second circuits include Rₙ gates and CNOT gates.
